(19) United States
(12) Patent Application Publication
(10) Pub. No.: US 2012/0156457 A1
(43) Pub. Date: Jun. 21, 2012

(54) MULTILAYER STRUCTURE WITH FLEXIBLE BASE MATERIAL AND SUPPORT, PANEL FOR USE IN ELECTRONIC DEVICE PROVIDED WITH SUPPORT AND PRODUCTION METHOD FOR PANEL FOR USE IN ELECTRONIC DEVICE

(75) Inventor: Satoshi Kondo, Tokyo (JP)

(73) Assignee: Asahi Glass Company, Limited

(21) Appl. No.: 13/404,565

(22) Filed: Feb. 24, 2012

Related U.S. Application Data
(63) Continuation of application No. PCT/JP2010/063947, filed on Aug. 18, 2010.

(30) Foreign Application Priority Data
Aug. 27, 2009 (JP) 2009-197201

(51) Int. Cl. B32B 7/02; B29C 41/42; B32B 3/00

(52) U.S. Cl. 428/215; 428/332; 264/334

(57) ABSTRACT

The present invention relates to a laminated structure including: a flexible base material having a first main surface and a second main surface and having a thickness of 0.3 mm or less; a supporting substrate; and a cured silicone resin layer provided between the flexible base material and the supporting substrate and having a peelable surface, in which the cured silicone resin layer is fixed onto a first main surface of the supporting substrate, has easy peelability against the first main surface of the flexible base material, and is adhered closely to the first main surface of the flexible base material.

### TECHNICAL FIELD

The present invention relates to a flexible base material-support laminated structure, a support-attached panel for electronic device, and a method for producing a panel for electronic device.

### BACKGROUND ART

In recent years, flexible electronic devices using a flexible material such as resins and the like as a substrate are paid attention. There are proposed wrist watches, body-worn type display devices, display devices capable of being installed in a curved part of an object, and so on. Since such a flexible device can be stored by balling up the device itself and can be reduced in weight and bent, it is basically suitable for ultra-thin/lightweight mobile appliances.

Also, as for an application, such a flexible device can be utilized for large-sized displays without being limited to small-sized devices. Furthermore, as for photovoltaic generation panels, for the purposes of achieving weight reduction and withdrawing restrictions regarding an installation location, flexible solar cells using a resin as a base material are being started to be paid attention.

However, as for liquid crystal displays (LCD), organic electroluminescence displayers (hereinafter referred to as “organic EL”), photovoltaic generation panels, and the like, which are widely used at present, a production technology for forming a device on a glass substrate is already established. A lot of manufacturers have production equipment subjective to such a glass substrate.

However, when it is intended to produce a flexible electronic device, its base material per se is low in rigidity so that it cannot be produced using a production step made on the assumption of a usual glass substrate.

In order to avoid such a problem, there is known a method of producing a device substrate for LCD by forming a peeling layer on a glass substrate having high heat resistance and high rigidity, then aligning a transparent electrode, a color filter layer or the like at a high precision to form a transfer layer, and subsequently transferring and forming this transfer layer on a resin base material (Patent Document 1).

However, in Patent Document 1, since the device to be formed is fabricated on the assumption of subsequent transfer, there is a defect that close adhesiveness at each interface is poor.

On the other hand, there is also known a method of forming a special pressure-sensitive adhesive layer, a pressure-sensitive adhesive force of which is lowered upon irradiation with light, on a supporting glass, laminating a flexible base material thereon to form an electronic device, and then irradiating light, thereby peeling the flexible base material (Patent Document 2).

### BACKGROUND ART DOCUMENTS

### Patent Document

Patent Document 1: JP-A-2002-214588
Patent Document 2: JP-A-2004-157307

### SUMMARY OF THE INVENTION

### Problems that the Invention is to Solve

However, in Patent Document 2, though a description regarding a specific production process of an electronic device is not given, in general, a usable temperature of a pressure-sensitive adhesive material, a pressure-sensitive adhesive force of which is lowered upon irradiation with light, is about 150° C., and its heat resistance is low. For that reason, for example, it is difficult to produce a high-performance TFT array requiring a treatment in a high temperature region (from 160 to 350° C.) on a flexible base material.

In view of the foregoing problem, the present invention has been made, and an object thereof is to provide a laminated structure which is excellent in heat resistance and in which a flexible base material and its support adhered closely to each other can be easily separated from each other.

### Means for Solving the Problems

A first embodiment of the present invention is to provide a laminated structure comprising: a flexible base material having a first main surface and a second main surface and having a thickness of 0.3 mm or less; a supporting substrate; and a cured silicone resin layer provided between the flexible base material and the supporting substrate and having a peelable surface, wherein the cured silicone resin layer is fixed onto a first main surface of the supporting substrate, has easy peelability against the first main surface of the flexible base material, and is adhered closely to the first main surface of the flexible base material.

A second embodiment of the present invention is to provide a support-attached panel for display device, for producing a panel for display device, in which at least a part of a constituent member of the panel for display device is formed on a surface of the flexible base material of the foregoing laminated structure.

A third embodiment of the present invention is to provide a method for producing a panel for flexible display device, the method comprising: forming at least a part of a constituent member of the panel for display device on a surface of the flexible base material of the foregoing laminated structure; and thereafter, separating the flexible base material and the cured silicone resin layer-attached supporting substrate from each other.

A fourth embodiment of the present invention is to provide a support-attached panel for light generating device, for producing a panel for light generating device, in which at least a part of a constituent member of the panel for light generating device is formed on a surface of the flexible base material of the foregoing laminated structure.

A fifth embodiment of the present invention is to provide a method for producing a panel for light generating device, the method comprising: forming at least a part of a constituent member of the panel for light generating device on a surface of the flexible base material of the foregoing laminated structure; and thereafter, separating the flexible base material and a cured silicone resin layer-attached supporting substrate from each other.

The present invention can be preferably applied to whole structures and partial structures of not only flexible electronic displays and flexible solar cells, but also other general-purpose electronic devices. For example, the present invention can be used as internal components in household appliances, which are required to be small in size and bendable.

### ADVANTAGE OF THE INVENTION

According to the present invention, a laminated structure which is excellent in heat resistance and in which a flexible base material and its support adhered closely to each other can be easily separated from each other can be provided. Also, a support-attached panel for electronic device which is obtained by using this laminated structure can be provided. Furthermore, a method for producing a panel for electronic device using the foregoing laminated structure can be provided.

### BRIEF DESCRIPTION OF THE DRAWINGS

FIG. 1 is a schematic sectional view of an embodiment of a support-attached panel for electronic device according to the present invention.

FIG. 2A is an explanatory view (1) of a production method of a panel for electronic device according to an embodiment of the present invention.

FIG. 2B is an explanatory view (2) of a production method of a panel for electronic device according to an embodiment of the present invention.

FIG. 2C is an explanatory view (3) of a production method of a panel for electronic device according to an embodiment of the present invention.

FIG. 2D is an explanatory view (4) of a production method of a panel for electronic device according to an embodiment of the present invention.

FIG. 2E is an explanatory view (5) of a production method of a panel for electronic device according to an embodiment of the present invention.

FIG. 2F is an explanatory view (6) of a production method of a panel for electronic device according to an embodiment of the present invention.

FIG. 3 is a schematic view showing a modification example of FIG. 2F.

### MODE FOR CARRYING OUT THE INVENTION

A support, a laminated structure containing a support, a support-attached panel for electronic device, and a panel for flexible electronic device according to the present invention are hereunder described in detail on the basis of preferred embodiments shown in the drawings.

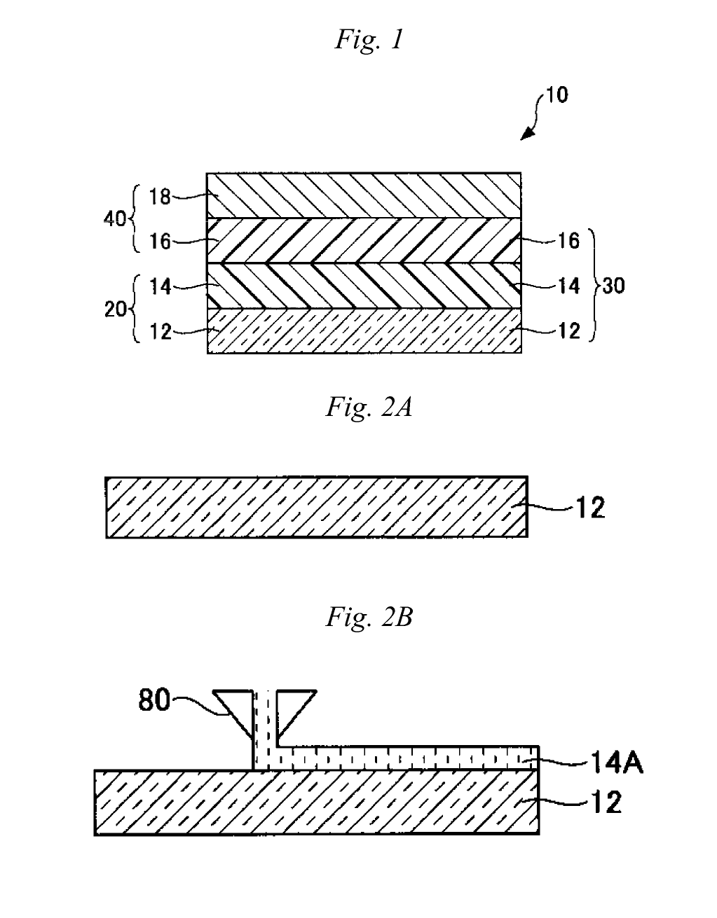

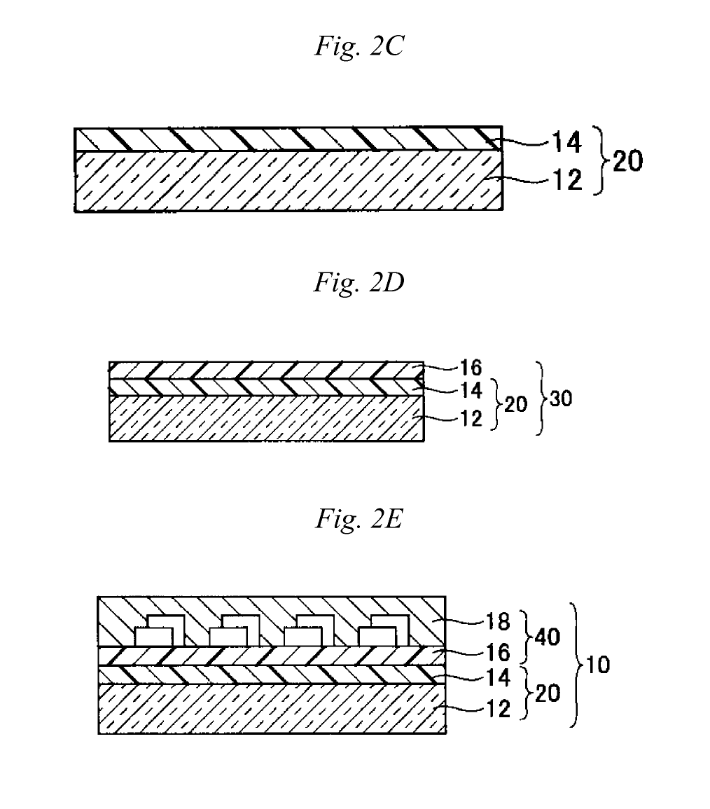

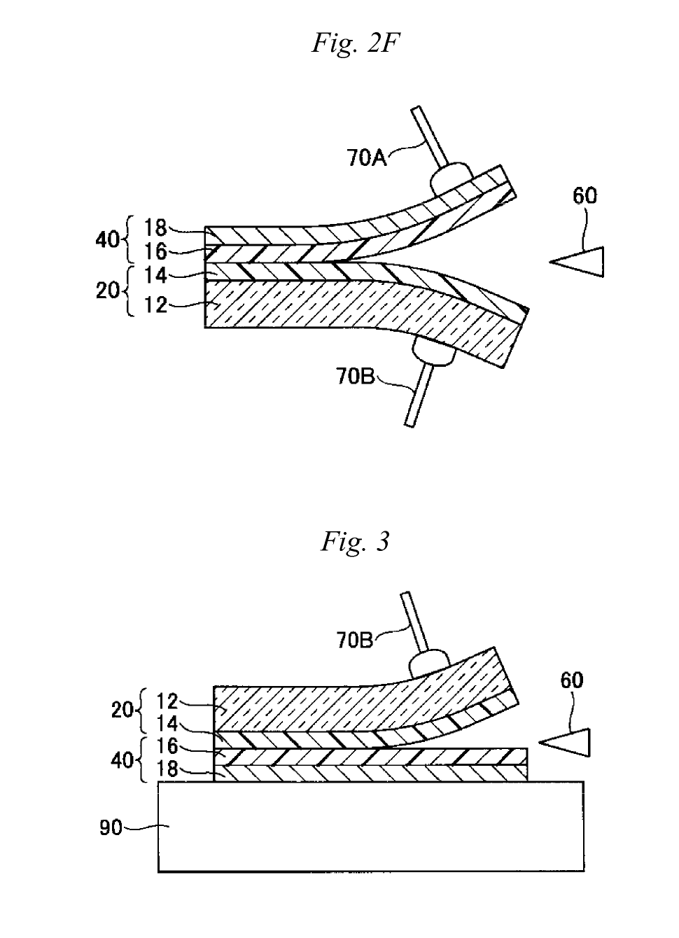

FIG. 1 is a schematic sectional view of an embodiment of a support-attached panel for electronic device of the present invention. A support-attached panel 10 for electronic device shown in FIG. 1 is one provided with a support 20 according to the present invention and has a laminated structure in which a supporting glass 12, a resin layer 14, a flexible base material 16, and a constituent member 18 of a panel for electronic device are laminated in this order. FIGS. 2A to 2F are explanatory views of a production method of a panel for electronic device according to an embodiment of the present invention; and FIG. 3 is a schematic view showing a modification example of FIG. 2F and is a schematic view showing a peeling method. These drawings are a schematic view, and there may be the case where an actual thickness or a relative relation of each layer is different from that illustrated in the drawings.

Incidentally, the supporting glass 12 and the resin layer 14 constitute the support 20 according to the present invention; the support 20 and the flexible base material 16 constitute a glass laminate (glass laminated structure) 30 according to the present invention; and the flexible base material 16 and the constituent member 18 of a panel for electronic device constitute a panel 40 for electronic device (one which is free from the support 20) according to the present invention.

First of all, each of the layers constituting the support 20, the glass laminate 30, the panel 40 for electronic device, and the support-attached panel 10 for electronic device according to the present invention is described.

### <Supporting Glass>

The supporting glass 12 which is used in the present invention is not particularly limited so far as it supports the flexible base material 16 via the resin layer 14 as described later, thereby reinforcing the strength of the flexible base material 16. Though a composition of the supporting glass 12 is not particularly limited, as for the composition, glasses having a variety of compositions, for example, alkali metal oxide-containing glasses (e.g., a soda lime glass, etc.), non-alkali glasses, and the like, can be used. Above all, non-alkali glasses are preferable because of a small heat shrinkage ratio thereof. For the purpose of removing stains, extraneous materials, or the like before forming the resin layer, it is preferable to wash the surface thereof in advance (see the symbol 12 of FIG. 1 and FIG. 2A).

Though a thickness of the supporting glass 12 is not particularly limited, it is preferably a thickness at which the glass laminate 30 of the present invention can be treated by a current production line of a panel for electronic device. For example, the thickness of glass substrates which are used for LCD at present is chiefly in the range of from 0.4 to 1.2 mm, and especially frequently 0.7 mm. In the present invention, it is assumed that a flexible base material made of a film that is thinner than this is used. On that occasion, so far as the thickness of the whole of the glass laminate 30 is approximately equal to that of the current glass substrates, it can be easily adapted to the current production line.

For example, in the case where the current production line is designed so as to treat a substrate having a thickness of 0.5 mm, and the thickness of the flexible base material 16 is 0.1 mm, the sum of the thickness of the supporting glass 12 and the thickness of the resin layer 14 is set 0.4 mm. Also, though it is the most general to design the current production line so as to treat a glass substrate having a thickness of 0.7 mm, for example, when the thickness of the flexible base material 16 is 0.2 mm, the sum of the thickness of the supporting glass 12 and the thickness of the resin layer 14 is set to 0.5 mm.

The flexible base material 16 in the present invention is not limited to liquid crystal display devices, but it is also aimed to make a photovoltaic generation panel or the like flexible. In consequence, though the thickness of the supporting glass 12 is not limited, it is preferably a thickness of from 0.1 to 1.1 mm. Furthermore, in order to ensure rigidity, the thickness of the supporting glass 12 is preferably thicker than that of the flexible base material 16. Also, the thickness of the supporting glass 12 is preferably 0.3 mm or more, and the thickness is more preferably from 0.3 to 0.8 mm, and still more preferably from 0.4 to 0.7 mm.

The surface of the supporting glass 12 may be a polished surface having been subjected to a treatment of mechanical polishing or chemical polishing, or it may be a non-etched surface (raw surface) not having been subjected to a polishing treatment. From the standpoints of productivity and costs, the surface of the supporting glass 12 is preferably a non-etched surface (raw surface).

The supporting glass 12 has a first main surface and a second main surface, and its shape is not limited. However, the shape is preferably a rectangle. Here, the rectangle is substantially generally rectangular and also includes a shape in which edges of the surrounding area are cut (corner cut). Though a size of the supporting glass 12 is not limited, for example, in the case of a rectangle, it may be 100 to 2,000 mm×100 to 2,000 mm, and it is preferably 500 to 1,000 mm×500 to 1,000 mm.

Incidentally, the supporting glass 12 is corresponding to the supporting substrate of the present invention. The supporting substrate is not limited in the kind thereof so far as it is able to support the flexible base material 16 via the resin layer 14, thereby reinforcing the strength of the flexible base material 16, and for example, it may be a metal substrate or a resin substrate.

### <Resin Layer: Basic Constitution>

The resin layer 14 according to the present invention is fixed onto the first main surface of the foregoing supporting glass 12, and in the glass laminate 30 laminated with the flexible base material 16, the resin layer 14 is adhered closely to the first main surface of the flexible base material 16 having a first main surface and a second main surface. A resin material 14A is discharged from a die 80 by a die coating method or the like and coated in a thin film form on the supporting glass 12, followed by drying to obtain the resin layer 14 having a desired thickness (the symbol 14 of FIG. 1 and FIGS. 2B and 2C). It is necessary that a peeling strength between the first main surface of the flexible base material 16 and the resin layer 14 is lower than a peeling strength between the first main surface of the supporting glass 12 and the resin layer 14. That is, in separating the flexible base material 16 and the supporting glass 12 from each other, it is necessary that peeling occurs at an interface between the first main surface of the flexible base material 16 and the resin layer 14, whereas peeling hardly occurs at an interface between the first main surface of the supporting glass 12 and the resin layer 14.

For that reason, the resin layer 14 has such a surface characteristic that it adheres closely to the first main surface of the flexible base material 16, whereas the flexible base material 16 can be easily peeled therefrom. That is, the resin layer 14 bonds to the first main surface of the flexible base material 16 at a bonding force to some extent, thereby restricting displacement or the like of the flexible base material 16, and at the same time, the resin layer 14 bonds at a bonding force to such an extent that in peeling the flexible base material 16, the flexible base material 16 can be easily peeled therefrom without causing breakage. In the present invention, the properties that this resin layer surface can be easily peeled are referred to as “easy peelability”. On the other hand, the first main surface of the supporting glass 12 and the resin layer 14 are bound to each other at a bonding force such that the both are relatively hardly peeled from each other.

In the glass laminate 30 of the present invention, the resin layer 14 and the flexible base material 16 are not attached to each other at a pressure-sensitive adhesive force which a pressure-sensitive adhesive has, but it is preferable that the both are attached to each other at a force caused due to a van der Waals force between solid molecules, namely a close adhesion force. However, in the case where it is required to increase a bonding force between the resin layer 14 and the flexible base material 16 depending upon an application of the glass laminate 30 (for example, a kind of the electronic device) or a kind of the production step of an electronic device, or the like, a pressure-sensitive adhesive force may also be utilized.

On the other hand, a bonding force of the resin layer 14 to the first main surface of the supporting glass 12 is relatively higher than the bonding force of the resin layer 14 to the first main surface of the flexible base material 16. In the present invention, the bonding to the first main surface of the flexible base material 16 is referred to as close adhesion, whereas the bonding to the first main surface of the supporting glass 12 is referred to as fixing.

Also, since flexibility of the resin layer 14 is high, even when an air bubble or an extraneous material such as a dust and the like is incorporated between the flexible base material 16 and the resin layer 14, the generation of a deformation defect in the flexible base material 16 can be suppressed.

For the purposes of making the peeling strength of the resin layer 14 to the first main surface of the flexible base material 16 relatively low and making the peeling strength of the resin layer 14 to the first main surface of the supporting glass 12 relatively high, it is preferable that the curable silicone resin composition (resin material) 14A is cured on the first main surface of the supporting glass 12 to form the resin layer 14 composed of a cured silicone resin (see FIGS. 2B and 2C), and thereafter, the flexible base material 16 is laminated on and adhered closely to the resin layer 14 composed of a cured silicone resin (see FIG. 2D). The cured silicone resin in the present invention is a resin the same as a non-pressure-sensitive adhesive cured silicone resin which is used for a release paper or the like, and even when adhered closely to the flexible base material 16, its peeling strength is low. But, it may be considered that when the curable silicone resin composition 14A serving as a cured silicone resin is cured on the surface of the supporting glass 12, it is adhered due to an interaction with the supporting glass surface at the time of a curing reaction, whereby the peeling strength of the cured silicone resin after curing to the supporting glass surface becomes high.

The formation of the resin layer 14 in which a difference between the peeling strength to the first main surface of the flexible base material 16 and the peeling strength to the first main surface of the supporting glass 12 is provided is not limited to the foregoing method. For example, in the case of using the supporting glass 12 made of a material having higher close adhesiveness to the cured silicone resin surface than that to the flexible base material 16, the flexible base material 16 and the supporting glass 12 can be simultaneously laminated while allowing a cured silicone resin film to intervene therebetween.

Also, in the case where adhesiveness by curing of the curable silicone resin composition 14A is sufficiently low against the flexible base material 16, and the adhesiveness is sufficiently high against the supporting glass 12, the resin layer 14 can be formed by curing the curable silicone resin composition 14A between the flexible base material 16 and the supporting glass 12. Also, the peeling strength to the resin layer 14 can be increased by applying a treatment for increasing the adhesiveness of the surface of the supporting glass 12. For example, the bonding force to the resin layer 14 can be increased by subjecting the surface of the supporting glass 12 to a treatment for increasing a concentration of a silanol group.

The curable silicone resin composition 14A which is used for the formation of the resin layer 14 is hereunder described in detail.

The curable silicone resin composition 14A in the present invention may be a curable composition containing a linear polyorganosiloxane having a vinyl group in both ends and/or side chain thereof, an organohydrogen polysiloxane having a hydrosilyl group in a molecule thereof, and additives such as a catalyst and the like, and it is cured by heating to form a cured silicone resin.

This cured silicone resin has very high heat resistance because three-dimensional crosslinking highly proceeds. Also, the cured silicone resin has such a surface characteristic that its surface tension is low, and other substances hardly attach thereto. Because of such characteristics, for example, after an electronic device production process proceeds, by applying a force in a vertical direction to the plane of the glass laminate 30, it is possible to smoothly peel the support 20 constituted of the resin layer 14, the supporting glass 12 and the like from the flexible base material 16.

On the other hand, since this cured silicone resin has moderate elasticity, it holds a flat base material, for example, the flexible base material 16 for forming a flexible electronic device, on the surface thereof and reveals a large drag against a shear force in a parallel direction to the plane of the laminated structure. In consequence, it is possible to continuously hold the flexible base material 16 for forming a flexible electronic device without causing a shear.

For example, the curable silicone resin composition 14A contains a linear organopolysiloxane (a) that is a linear organovinylpolysiloxane represented by the following formula (1) and a linear organopolysiloxane (b) that is an organohydrogen polysiloxane represented by the following formula (2).

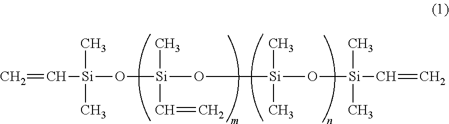

In the formula, each of m and n represents an integer and may be 0. In the case where m is 0, a linear polyorganosiloxane having a vinyl group in both ends thereof is presented. In the case where m is an integer of 1 or more, a linear polyorganosiloxane having a vinyl group in both ends and side chain thereof is presented. Incidentally, a compound having a vinyl group only in a side chain thereof may also be used as the linear polyorganosiloxane.

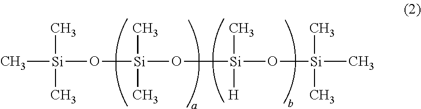

In the formula, a represents an integer, and b represents an integer of 1 or more. Incidentally, a part of the terminal methyl groups of the organohydrogen polysiloxane may be a hydrogen atom or a hydroxyl group.

In general, as compared with other curable silicone resins, a curable silicone resin of addition reaction type is easy to cause a curing reaction and low in curing shrinkage, and a degree of peelability of a cured material thereof is satisfactory. Above all, in particular, the cured material of the curable silicone resin composition 14A of addition reaction type in the present invention is small in a temporal change of peeling strength and excellent in heat resistance.

Also, in general, as for curable silicone resin compositions of addition reaction type, compositions of a solvent type, an emulsion type, and a non-solvent type are used, respectively from the standpoint of morphology. As for the curable silicone resin composition 14A in the present invention, compositions of all of these types can be used.

Though a mixing ratio of the linear organopolysiloxane (a) and the linear organopolysiloxane (b) in the curable silicone resin composition 14A is not particularly limited, it is preferable to adjust the mixing ratio such that a molar ratio of the hydrogen atoms bound to the silicon atom (hydrosilyl group) in the linear organopolysiloxane (b) to all vinyl groups in the linear organopolysiloxane (a) (hydrosilyl group/vinyl group) is from 1.3/1 to 0.7/1. Above all, it is preferable to adjust the mixing ratio such that the molar ratio is from 1.0/1 to 0.8/1.

In the case where the molar ratio (hydrosilyl group/vinyl group) exceeds 1.3/1, the peeling strength of the cured silicone resin after allowing it to stand over a long period of time is easy to increases, so that there may be a possibility that the peelability is not sufficient. Also, in the case where the molar ratio (hydrosilyl group/vinyl group) is less than 0.7/1, a crosslinking density of the cured silicone resin is lowered, so that there may be a possibility that problems are caused in chemical resistance and the like.

Also, each of the linear organopolysiloxane (a) and the linear organopolysiloxane (b) in the curable silicone resin composition 14A may be a mixture of compounds having a plurality of molecular weights and structures.

### <Resin Layer: Required Physical Properties and the Like>

A thickness of the resin layer 14 comprising the foregoing cured silicone resin is not particularly limited, and an optimum thickness is properly chosen depending upon a kind of the flexible base material 16 and the like. Above all, the thickness of the resin layer 14 is preferably from 5 to 50 μm, more preferably from 5 to 30 μm, and still more preferably from 7 to 20 μm. So far as the thickness of the resin layer 14 falls within such a range, the close adhesion between the surface of the flexible base material 16 and the resin layer 14 is more satisfactory. Also, even when an air bubble or an extraneous material intervenes, the generation of a deformation defect in the flexible base material 16 can be more suppressed. Also, when the thickness of the resin layer 14 is too thick, the time and materials are required for the formation of the resin layer, and hence, such is not economical.

Incidentally, the resin layer 14 may be constituted of two or more layers. In that case, the “thickness of the resin layer” means a thickness of the total sum of all of the layers. Also, in the case where the resin layer 14 is constituted of two or more layers, a kind of the resin for forming each of the layers may be different.

In the resin layer 14, a surface tension of its peelable surface is preferably 30 mN/m or less, more preferably 25 mN/m or less, and still more preferably 22 mN/m or less. Though a lower limit thereof is not particularly limited, it is preferably 15 mN/m or more.

When the resin layer 14 has such a surface tension, it can be more easily peeled from the surface of the flexible base material 16.

It is preferable that the resin layer 14 comprising a material having a glass transition point of lower than room temperature (about 25° C.) or having no glass transition point. This is because so far as the resin layer 14 has such a glass transition point, it can also have moderate elasticity while keeping non-pressure-sensitive adhesiveness and can be more easily peeled from the surface of the flexible base material 16, and at the same time, its close adhesion to the surface of the flexible base material 16 is sufficient.

Also, it is preferable that the resin layer 14 has excellent heat resistance. This is because for example, in the case where the constituent member 18 of panel for electronic device is formed on the second main surface of the flexible base material 16, it is able to subject the glass laminate 30 of the present invention to a heat treatment under a high temperature condition. The foregoing cured silicone resin in the present invention has sufficient heat resistance such that it withstands this heat treatment.

More specifically, a heat decomposition initiation temperature of the resin layer 14 composed of the foregoing cured silicone resin in the present invention can be set to 400° C. or higher in such a state that the glass is laminated on the resin layer surface. This heat-resistant temperature is more preferably 420° C. or higher, and especially preferably from 430° C. to 450° C.

So far as the heat-resistant temperature falls within the foregoing range, in the glass laminate 30 having the flexible base material 16 laminated on the surface of the resin layer 14, the decomposition of the resin layer is suppressed even under a high temperature condition (about 350° C. or higher) of a production process of a TFT array or the like, and the generation of foaming, or the like in the glass laminate 30 is more suppressed. In this way, in the present invention, the support 20 has extremely high heat resistance, and therefore, the heat resistance as the glass substrate 30 is dominated chiefly by the heat resistance of the flexible base material 16 per se as described later.

Incidentally, the heat decomposition initiation temperature as the support 20 is expressed by the following measurement method.

An evaluation sample is prepared by forming the resin layer 14 (thickness: from about 15 to 20 μm) on the supporting glass 12 of 50 mm square (thickness: from about 0.4 to 0.6 mm) and further laminating a glass substrate having the same size of 50 mm square (thickness: from about 0.1 to 0.4 mm) thereon. Then, the sample is placed on a hot plate heated at 300° C. and heated at a temperature rising speed of 10° C. per minute, and a temperature at which a foaming phenomenon is recognized within the sample is defined as the heat decomposition initiation temperature as the support 20.

Also, when an elastic modulus of the resin layer 14 is too high, its close adhesiveness to the surface of the flexible base material 16 tends to become low. On the other hand, when the elastic modulus is too low, there may be the case where the peelability becomes low. The foregoing cured silicone resin in the present invention has an elastic modulus such that this required performance is satisfied.

### <Other Constituent Component (1)>

The curable silicone resin composition 14A in the present invention may contain a variety of additives within the range where the effects of the present invention are not impaired, as the need arises. As the additives, in general, it is preferable to add a catalyst capable of accelerating a reaction between the hydrogen atom bound to the silicon atom and the vinyl group. As this catalyst, it is preferable to use a platinum based catalyst.

A mass ratio of the catalyst is preferably from 0.02 to 5% relative to a total mass of the linear organopolysiloxane (a) and the linear organopolysiloxane (b). The mass ratio is more preferably from 0.05 to 2%, and still more preferably from 0.1 to 1%.

In the curable silicone resin composition 14A in the present invention, it is preferable to further jointly use an activity suppressing agent (a compound also called a reaction inhibitor, a retarding agent, or the like) having an action to suppress a catalytic activity for the purpose of adjusting the catalytic activity, together with the catalyst. Also, though a dispersing medium such as an organic solvent, for example, hexane, heptane, octane, toluene, xylene, etc., water, and the like is a component which does not constitute the cured silicone resin, it can be blended and used in the curable silicone resin composition 14A in the present invention for the purposes of an enhancement of workability for coating the curable silicone resin composition 14A, and the like.

### <Other Constituent Component (2)>

The curable silicone resin composition 14A may further contain a polyorganosiloxane containing an R¹₃SiO_{0.5} unit (R¹ is an aliphatic unsaturated bond-free monovalent hydrocarbon group having from 1 to 10 carbon atoms) and an SiO₂ unit and having a molar ratio of the R¹₃SiO_{0.5} unit to the SiO₂ unit of from 0.5 to 1.7. This polyorganosiloxane is one which is contained in general silicone pressure-sensitive adhesive compositions of addition reaction type.

It is preferable that the silicone pressure-sensitive adhesive composition of addition reaction type comprises components such as:

(A) a polyorganosiloxane having an alkenyl group (for example, a vinyl group, etc.);

(B) a polyorganosiloxane containing an R¹₃SiO_{0.5} unit and an SiO₂ unit and also having a molar ratio of the R¹₃SiO_{0.5} unit to the SiO₂ unit of from 0.5 to 1.7;

(C) a polyorganosiloxane containing an SiH group; and

(D) a platinum catalyst.

Of these components, the component (A), the component (C) and the component (D) are already contained in the foregoing curable silicone resin composition 14A. For example, the component (A) is corresponding to the foregoing linear polyorganosiloxane having a vinyl group in both ends and/or side chain thereof; and the component (C) is corresponding to the foregoing organohydrogen polysiloxane having a hydrosilyl group in a molecule thereof.

In the component (B), R¹ is, for example, an alkyl group such as a methyl group, an ethyl group, a propyl group, a butyl group, and the like, a cycloalkyl group such as a cyclohexyl group and the like, an aryl group such as a phenyl group, a tolyl group, and the like, a vinyl group, or the like, with a methyl group, a phenyl group, or a vinyl group being especially preferable.

In the component (B), by allowing the molar ratio of the R¹₃SiO_{0.5} unit to the SiO₂ unit to be from 0.5 to 1.7, a satisfactory pressure-sensitive adhesive force can be obtained. At that time, the component (B) may contain an SiOH group, and an OH group content may be from 0 to 4.0% by mass. What the OH group content exceeds 4.0% by mass is not preferable because curability is lowered. Also, the component (B) may contain an R¹SiO_{1.5} unit or an R¹₂SiO unit within the range where the pressure-sensitive adhesive force is not impaired.

Though a kind of the silicone adhesive composition of addition reaction type is not particularly limited, examples of those which are commercially available include (1) products Nos. TSR1512, TSR1516, and TSR1521, all of which are manufactured by Momentive Performance Materials Inc.; (2) products Nos. KR-3700, KR-3701, X-40-3237-1, X-40-3240, X-40-3291-1, X40-3229, X40-3270, and X-40-3306, all of which are manufactured by Shin-Etsu Silicones Co., Ltd.; (3) products Nos. SD4560, SD4570, SD4580, SD4584, SD4587L, SD4592, and BY24-740, all of which are manufactured by Dow Corning Toray Silicone Co., Ltd.

Since the resin layer 14 obtained by curing this curable silicone resin composition 14A has pressure-sensitive adhesiveness, it can enhance a bonding force between the resin layer 14 and the flexible base material 16 and suppress unintended peeling between these 14 and 16.

In this curable silicone resin composition 14A, a mixing weight ratio (A/B) of the polyorganosiloxane (A) and the polyorganosiloxane (B) is preferably from 20/80 to 80/20. By allowing the mixing weight ratio (A/B) to be 80/20 or less, a sufficient pressure-sensitive adhesive force can be revealed. On the other hand, when the mixing weight ratio (A/B) is less than 20/80, the heat resistance of the resin layer 14 is too low. A more preferred range thereof is from 30/70 to 70/30, and a still more preferred range thereof is from 40/60 to 60/40.

Incidentally, in the case where a high bonding force between the resin layer 14 and the flexible base material 16 is not required, in order to increase the easy peelability, the curable silicone resin composition 14A may not contain the foregoing polyorganosiloxane (B), and the mixing weight ratio (A/B) may be 100/0.

Incidentally, it may be possible to use, as the curable silicone resin composition 14A, one obtained by mixing a silicone pressure-sensitive adhesive composition of condensation reaction type in place of the silicone pressure-sensitive adhesive composition of addition reaction type. However, in that case, such is not preferable because a reaction product such as an alcohol, water, and the like is contained in the inside of the resin layer 14.

### <Other Constituent Component (3)>

The curable silicone resin composition 14A may further contain a silane coupling agent. According to this, the surface of the supporting glass 12 is activated, whereby the bonding force between the supporting glass 12 and the resin layer 14 can be enhanced, and unintended peeling between these 12 and 14 can be suppressed.

The addition of the silane coupling agent is suitable in the case where the curable silicone resin composition 14A contains the foregoing polyorganosiloxane (B). This is because in that case, the resin layer 14 has pressure-sensitive adhesiveness, so that a peeling strength between the resin layer 14 and the flexible base material 16 is high.

Though a kind of the silane coupling agent is not particularly limited, examples thereof include amino silane, epoxy silane, vinyl silane, mercapto silane and methacryl (acryl) silane. Of these, vinyl silane is especially preferable.

The curable silicone resin composition 14A containing a silane coupling agent may be fixed onto the surface of the supporting glass 12 after curing so far as the surface of the supporting glass 12 can be activated. However, in order to sufficiently activate the surface of the supporting glass 12, it is desirable to install the curable silicone resin composition 14A containing a silane coupling agent on the supporting glass 12 before curing.

Incidentally, in the case of using, as the supporting substrate, a metal substrate, a resin substrate, or the like in place of the supporting glass 12, by using a silane coupling agent, the same effects can also be obtained.

### <Formation of Resin Layer>

As described above, it is preferable that the curable silicone resin composition 14A is cured on the first main surface of the supporting glass 12 to form the resin layer 14 comprising a cured silicone resin. For that reason, the curable silicone resin composition 14A is coated on one surface of the supporting glass 12 to form a layer of the curable silicone resin composition 14A, and subsequently, the foregoing curable silicone resin composition 14A is cured to form the foregoing cured silicone resin layer 14. In forming the layer of the curable silicone resin composition 14A, in the case where the curable silicone resin composition 14A is a flowable composition, it is coated as it is; whereas in the case where the curable silicone resin composition 14A is a composition having low fluidity or a composition having no fluidity, it is coated after being blended with an organic solvent. Also, an emulsified solution, a dispersed solution, or the like of the curable silicone resin composition 14A can be used. A coating film containing a volatile component such as an organic solvent and the like is subsequently subjected to evaporation-removal of the volatile component, thereby forming a layer of the curable silicone resin composition 14A. Curing of the curable silicone resin composition 14A can be carried out in succession to the evaporation-removal of the volatile component (see FIGS. 2B and 2C).

It should not be construed that curing of the curable silicone resin composition 14A is limited to the foregoing methods. The support 20 can be, for example, produced by curing the curable silicone resin composition 14A on a certain peelable surface to produce a film of the cured silicone resin and laminating this film on the supporting glass 12. Also, in the case where the curable silicone resin composition 14A does not contain a volatile component, as described above, it can be cured upon being interposed between the flexible base material 16 and the supporting glass 12.

In the case where the curable silicone resin composition 14A is coated on one surface of the supporting glass to form a layer of the curable silicone resin composition 14A, the coating method is not particularly limited, and conventionally known methods are exemplified. Examples thereof include a spray coating method, a die coating method, a spin coating method, a dip coating method, a roll coating method, a bar coating method, a screen printing method, and a gravure coating method. Among these methods, the coating method can be properly selected depending upon a kind of the composition. For example, in the case where a volatile component is not blended in the curable silicone resin composition 14A, a die coating method, a spin coating method, or a screen printing method is preferable. In the case of a composition in which a volatile component such as a solvent and the like is blended, the volatile component is removed by heating or the like before curing, and the composition is then cured.

A condition for curing the curable silicone resin composition 14A varies depending upon a kind of the organopolysiloxane to be used or the like, and an optimum condition can be properly selected. In general, a heating temperature is preferably from 50 to 300° C., and a treatment time is preferably from 5 to 300 minutes.

Though a more specific heat curing condition also varies depending upon a blending amount of the catalyst, for example, in the case of blending 2 parts by mass of a platinum based catalyst relative to 100 parts by mass of a total amount of resins contained in the curable silicone resin composition 14A, the composition is cured through a reaction in the atmosphere at from 50° C. to 300° C., and preferably from 100° C. to 270° C. Also, in that case, a reaction time is set to from 5 to 180 minutes, and preferably from 60 to 120 minutes.

When the resin layer has a low silicone migration property, in peeling the flexible base material 16, the components in the resin layer 14 hardly migrate into the flexible base material 16. In order to form a resin layer having a low silicone migration property, it is preferable to allow the curing reaction to proceed as far as possible such that an unreacted silicone component does not remain in the resin layer 14.

The foregoing reaction temperature and reaction time are preferable because the unreacted organosilicone component can be allowed to not substantially remain in the resin layer 14. When too longer than the foregoing reaction time or too higher than the foregoing reaction temperature, oxidation decomposition of the organosilicone component or the cured silicone resin simultaneously occurs, and an organosilicone component having a low molecular weight is formed, thereby causing a possibility of increase in the silicone migration property. What the curing reaction is allowed to proceed as far as possible such that an unreacted silicone component does not remain in the resin layer 14 is preferable in view of making peelability after the heat treatment satisfactory.

### <Surface Treatment of Resin Layer>

The surface on the side of the flexible base material 16 of the resin layer 14 after curing may be a surface having been subjected to a UV ozone treatment in advance before installation (preferably just before installation) of the flexible base material 16. According to this, the surface of the resin layer 14 is activated, whereby the bonding force between the resin layer 14 and the flexible base material 16 can be increased. This effect is conspicuous in the case where the resin layer 14 has pressure-sensitive adhesiveness. That is, this effect is conspicuous in the case where the curable silicone resin composition 14A contains the polyorganosiloxane (B).

The UV ozone treatment is, for example, carried out by placing an objective on a stage within a chamber and irradiating UV light on the surface of the objective, and simultaneously producing ozone by the UV light.

Though an illuminance of the UV light is properly selected depending upon a kind of the resin layer 14, an ozone concentration, or the like, for example, it is preferably from 5 to 30 mW/cm² (measuring wavelength: 254 nm), and more preferably from 10 to 20 mW/cm² (measuring wavelength: 254 nm).

Though the concentration of ozone within the chamber is properly selected depending upon a kind of the resin layer 14, an illuminance of the UV light, or the like, for example, it is preferably from 0.01 to 200 ppm in terms of a volume ratio. Incidentally, the lower the ozone concentration, the larger the illuminance of the UV light is required to be set.

### <Surface Treatment of Supporting Glass>

For the purpose of imparting a high fixing force (high peeling strength) between the resin layer 14 and the supporting glass 12, a surface modification treatment (priming treatment) may be applied onto the surface of the supporting glass 12. For example, there are exemplified a chemical method of chemically enhancing the fixing force such as use of a silane coupling agent (primer treatment), a physical method of increasing a surface active group such as a flame treatment, a mechanical treatment method of increasing engagement by increasing a roughness of the surface such as a sand blast treatment, and so on.

Next, the surface treatment using a silane coupling agent is described.

The surface of the supporting glass 12 on the side of the resin layer 14 may be a surface having been subjected to a surface treatment with a silane coupling agent in advance before installation (preferably just before installation) of the resin layer 14 or the curable silicone resin composition 14A serving as the resin layer 14. According to this, the surface of the supporting glass 12 is activated, whereby the bonding force between the supporting glass 12 and the resin layer 14 can be enhanced, and unintended peeling between these 12 and 14 can be suppressed.

The surface treatment with a silane coupling agent is suitable in the case where the curable silicone resin composition 14A contains the foregoing polyorganosiloxane (B). This is because in that case, the resin layer 14 has pressure-sensitive adhesiveness, so that a peeling strength between the resin layer 14 and the flexible base material 16 is high.

Though a kind of the silane coupling agent is not particularly limited, examples thereof include amino silane, epoxy silane, vinyl silane, mercapto silane, methacryl (acryl) silane, and so on. Of these, vinyl silane is especially suitable.

This surface treatment is carried out in place of (or in addition to) the addition treatment of adding a silane coupling agent to the curable silicone resin composition 14A. The surface treatment is excellent in an activating effect (in its turn, an enhancement of the bonding force), whereas the addition treatment is excellent in workability.

Incidentally, in the case of using, as the supporting substrate, a metal substrate, a resin substrate, or the like in place of the supporting glass 12, by using a silane coupling agent, the same effects can also be obtained.

### <Flexible Base Material>

As the flexible base material 16 which is used in the present invention, there are exemplified a resin film, a metal film, a glass/resin composite film, and so on. Incidentally, with respect to transparency of the flexible base material 16, in the case where the electronic device to be produced is LCD, and in the case where the electronic device is an array on the light collecting side of OLED or an array on the sunlight incident side of a photovoltaic generation panel, it is essential that the flexible base material 16 is transparent. On the other hand, for the purpose of producing a back plate of an organic EL display of top emission type, a back plate of a photovoltaic generation panel, or the like, it is not necessary that the flexible base material 16 is transparent. In consequence, it is possible to use a non-transparent material (the symbol 16 of FIG. 1).

As the resin film which is preferably used for the flexible base material 16, examples of resins for transparent film include polyethylene terephthalate resins, polycarbonate resins, transparent fluorine resins, transparent polyimide resins, polyether sulfone resins, polyethylene naphthalate resins, polyacrylic resins, cycloolefin resins, silicone resins, silicone based organic/inorganic hybrid resins and organic polyamer/bionanofiber hybrid resins. Also, examples of resins for non-transparent film include polyimide resins, fluorine resins, polyamide resins, polyaramid resins, polyetheretherketone resins, polyetherketone resins and various liquid crystal polyamide resins. Also, materials obtaining by forming a function-imparting layer such as a barrier layer and the like on the surface of the foregoing film are preferable.

The flexible base material 16 is required to withstand a temperature condition of the electronic device forming process in view of the fact that an electronic device is formed on the surface thereof. Though the temperature condition of the electronic device forming process includes various conditions, it is preferable that the flexible base material 16 withstands a condition of approximately 120° C. or higher. Then, as for the heat resistance of the resin film which is used as the flexible base material 16, it is preferable that when measured at a temperature rising speed of 10° C. per minute, a 5% heat weight reduction temperature thereof is 150° C. or higher. Furthermore, the 5% heat weight reduction temperature is more preferably 180° C. or higher. In this viewpoint, all of the foregoing resins are those having a 5% heat weight reduction temperature exceeding 150° C.

Next, the metal film which is preferably used for the flexible base material 16 is not particularly limited with respect to a kind thereof, and examples thereof include stainless steel films and copper-made films.

Also, extremely high moisture permeation resistance is required for the base material for OLED. Then, in particular, a laminated structure of hybrid type of a glass and a resin (resin/glass laminated film material) is suitably used for an application in which such a high moisture permeation resistance performance is required. Even in use of a glass film alone, though sufficiently high moisture permeation resistance is revealed, the thinner the glass, the more conspicuous the appearance of “brittleness” which is an original nature is, and hence, it is difficult to provide a glass film alone for a flexible electronic device forming base material. Then, in a sense of compensating this “brittleness”, it is effective to take a form of a laminated structure of hybrid type of a glass and a resin.

The glass film which is used for the flexible base material 16 is not particularly limited with respect to its production method, and it can be produced by conventionally known methods. For example, the glass film can be obtained by melting conventionally known glass raw materials to form a molten glass, which is then molded in a plate form by a float process, a fusion process, a slot downdraw process, a redraw process, a lifting process, or the like. As the resin film which is laminated together with the foregoing glass film, the foregoing resin films are similarly exemplified.

Then, as for a lamination method of the foregoing glass film and resin film, the lamination may be carried out while allowing an adhesive layer or a pressure-sensitive adhesive layer to intervene therebetween, and so far as the resin film is a thermoplastic resin film, it is also effective to carry out heat fusion. Also, after subjecting the glass film surface to a treatment with a silane coupling agent or the like, it may be subjected to heat pressure bonding with the resin film, or other means. As for the lamination method, nip rollers, heating type nip rollers, a vacuum press, a heating/pressurization press apparatus, or the like may be used.

In the case where a laminated film of hybrid type of a glass film and a resin film is used as the flexible base material 16, from the viewpoints of solvent resistance and surface smoothness thereof, it is preferable to form an electronic device on the glass surface. Then, in that case, a glass is selected for the second main surface of the flexible base material 16.

In the flexible base material 16, in view of the fact that the application is concerned with a flexible electronic device, it is required that a thickness of the base material is 0.3 mm or less. In the case where the thickness of the base material is 0.3 mm or more, it is not preferable because the flexibility is impaired, an aspect of which, however, varies depending upon a material thereof. The thickness of the base material is more preferably 0.25 mm or less, and more preferably 0.2 mm or less. Incidentally, in the case where the flexible base material 16 is a laminated film of a glass and a resin, it is preferable that not only the thickness of the glass film is 0.1 mm or less, but also the thickness of the resin film is 0.2 mm or less. When the thickness of the glass is thicker than 0.1 mm, rigidity of the glass is extremely high as compared with that of the resin. For that reason, the flexibility of the laminated film material of hybrid type of a glass and a resin disappears, and hence, such is not preferable.

The flexible base material 16 has a first main surface and a second main surface, and its shape is not particularly limited. However, the shape is preferably a rectangle. Here, the rectangle is substantially generally rectangular and also includes a shape in which edges of the surrounding area are cut (corner cut).

Though a size of the flexible base material 16 is not limited, for example, in the case of a rectangle, it may be 100 to 2,000 mm×100 to 2,000 mm, and it is preferably 500 to 1,000 mm×500 to 1,000 mm. With preferred thickness and size as described above, in the glass laminate 30 of the present invention, the flexible base material 16 and the support 20 can be easily peeled from each other.

The characteristics of the flexible base material 16, such as a heat shrinkage ratio, a surface shape, chemical resistance, and the like, are not particularly limited and vary depending upon a kind of a panel for electronic device to be produced.

However, it is preferable that the heat shrinkage ratio of the flexible base material 16 is small. Specifically, a linear expansion coefficient that is an index of the heat shrinkage ratio is preferably 700×10⁻⁷/° C. or less, more preferably 500×10⁻⁷/° C. or less, and still more preferably 300×10⁻⁷/° C. or less. The reason for this resides in the matter that when the heat shrinkage ratio is large, a highly precise display device is hardly fabricated.

Incidentally, the linear expansion coefficient means one defined in conformity with JIS K7197.

### <Glass Laminate>

In the drawings, the glass laminate 30 according to the present invention is constituted of the foregoing supporting glass 12, resin layer 14 and flexible base material 16. As described above, the resin layer 14 has a peelable surface, and the flexible base material 16 or the panel 40 for electronic device (the flexible base material 16 having the constituent member 18 for electronic device formed thereon) can be easily peeled therefrom. More specifically, a peeling strength between the surface of the resin layer 14 and the surface of the flexible base material 16 is preferably 8.5 N/25 mm or less, more preferably 7.8 N/25 mm or less, and especially preferably 4.5 N/25 mm or less. In the case where the peeling strength falls within the foregoing range, it is preferable because breakage of the resin layer 14, breakage of the flexible base material 16, or the like hardly occurs at the time of peeling.

With respect to a lower limit thereof, there may be presented a close adhesion force to such an extent that the flexible base material 16 does not cause displacement on the resin layer 14. Though the lower limit is properly set up depending upon a dimensional shape or a kind of the flexible base material 16, in general, it is preferably 0.3 N/25 mm or more.

Incidentally, the peeling strength between the surface of the resin layer 14 and the surface of the flexible base material 16 is expressed by the following measurement method.

An evaluation sample is prepared by forming the resin layer 14 (thickness: from about 15 to 20 μm) on an entire surface of the supporting glass 12 of 25×75 mm square (thickness: from about 0.4 to 0.6 mm) and further laminating the flexible base material 16 of 25×50 mm square (thickness: from about 0.1 to 0.3 mm) thereon. Then, a non-sucked surface of the flexible base material 16 of this sample is fixed to an end of a table by a double-sided adhesive tape, and a central part of the protruding supporting glass 12 (25×25 mm) is pushed up vertically using a digital force gage, and a peeling strength is measured.

On the other hand, a peeling strength between the surface of the resin layer 14 and the surface of the supporting glass 12 is preferably 9.8 N/25 mm or more, more preferably 14.7 N/25 mm or more, and especially preferably 19.6 N/25 mm or more. In the case where the foregoing peeling strength is presented, when the flexible base material 16 and the like are peeled from the resin layer 14, peeling between the supporting glass 12 and the resin layer 14 hardly occurs, and the glass laminate 30 can be easily separated into the flexible base material 16 and the support 20 (the laminate of the supporting glass 12 and the resin layer 14).

As described above, this peeling strength can be easily achieved by curing the curable silicone resin composition 14A on the supporting glass 12. Also, when the peeling strength between the surface of the resin layer 14 and the surface of the supporting glass 12 is too high, there is a concern that when peeling between the supporting glass and the resin layer is necessary for the purpose of re-use of the supporting glass or the like, the peeling becomes difficult. In consequence, the peeling strength between the surface of the resin layer 14 and the surface of the supporting glass 12 is preferably 29.4 N/25 mm or less. Also, the peeling strength between the surface of the resin layer 14 and the surface of the supporting glass 12 is higher preferably by at least 10 N/25 mm, and more preferably by at least 15 N/25 mm than the peeling strength between the surface of the resin layer 14 and the surface of the flexible base material 16.

### <Production Method of Glass Laminate>

For the production of the glass laminate 30, a method of laminating the flexible base material 16 on the surface of the resin layer 14 of the support 20 (lamination method) is preferable (see FIGS. 2C and 2D). However, as described above, the production method of the glass laminate 30 is not limited to this lamination method. According to the lamination method, it may be considered that the first main surface of the flexible base material 16 and the peelable surface of the resin layer 14 can be bound to each other by a force to be caused due to a van der Waals force between very adjacent opposing solid molecules, namely a close adhesion force. In consequence, in that case, the supporting glass 12 and the flexible base material 16 can be held in such a state that the both are laminated via the resin layer 14. The production method of the glass laminate 30 by a method of laminating the flexible base material 16 on the surface of the resin layer 14 of the foregoing support 20 is hereunder described.

The method of laminating the flexible base material 16 on the surface of the resin layer 14 fixed to the supporting glass 12 is not particularly limited and can be carried out by adopting a known method. Examples thereof include a non-contact pressure bonding method in which the flexible base material 16 is laminated on the surface of the resin layer 14 under an atmospheric pressure environment, and thereafter, a press chamber is used; a method in which the resin layer 14 and the flexible base material 16 are pressure-bound using a roll or a press; and so on. It is preferable to carry out pressure bonding by a press chamber, a roll, a press, or the like because the resin layer 14 and the flexible base material 16 are more closely adhered to each other.

Also, it is preferable to carry out pressure bonding by pressing with a gas and by a roll or a press because an air bubble incorporated between the resin layer 14 and the flexible base material 16 is relatively easily removed. It is more preferable to carry out pressure bonding by a vacuum lamination method or a vacuum press method because suppression of incorporation of an air bubble or securement of satisfactory close adhesion can be more satisfactorily attained. By carrying out pressure bonding under vacuum, there is also such an advantage that even in the case where a fine air bubble remains, the air bubble does not grow by heating, scarcely leading to a deformation defect of the flexible base material 16.

In lamination of the support 20 and the flexible base material 16, it is preferable to sufficiently wash the surface of the flexible base material 16 and to carry out lamination under an environment with a high degree of cleanness. Even when extraneous materials are incorporated between the resin layer 14 and the flexible base material 16, since the resin layer deforms, flatness of the surface of the glass substrate is not influenced. However, what the degree of cleanness is higher is preferable because the flatness becomes satisfactory.

### <Constituent Member of Panel for Electronic Device>

In the present invention, the constituent member 18 of a panel for electronic device means a member formed on the flexible base material or a part thereof in a display device using a flexible base material, such as LCD, OLED, and the like, or a light generating device. For example, in a display device such as LCD, OLED, and the like, a TFT array (hereinafter referred to simply as “array”), a transparent electrode made of ITO, or the like is formed on the surface of a flexible substrate. Furthermore, a protective layer or other layer is formed, as the need arises. Also, as for a color filter substrate, colored layers for color pixels of RGB are formed. Furthermore, a liquid crystal layer is interposed between a front substrate and a rear substrate, and members such as various circuit patterns for driving and the like, or a combination thereof is formed (see FIG. 2E).

Also, for example, in a display device composed of OLED, there are exemplified a transparent electrode, a hole injection layer, a hole transporting layer, a light emitting layer, an electron transporting layer, and the like formed on a flexible base material. For example, in a light generating device composed of an organic thin film solar cell, there are exemplified a transparent electrode, a p-n organic semiconductor layer, a rear surface electrode, and the like formed on a flexible base material.

The panel 40 for electronic device composed of the flexible base material 16 and the constituent member 18 is a flexible base material in which at least a part of the foregoing member is formed. In consequence, for example, a flexible base material having an array formed therein or a flexible base material having a transparent electrode formed therein is corresponding to the panel 40 for electronic device.

### <Support-Attached Panel for Electronic Device>

In FIG. 1, the support-attached panel 10 for electronic device is provided with the supporting glass 12, the resin layer 14, the flexible base material 16, and the constituent member 18 of a panel for electronic device.

Incidentally, the support-attached panel 10 for electronic device also includes, for example, an embodiment in which an array-formed surface of a support-attached panel for electronic device in which an array is formed on a second main surface of a glass substrate and a color filter-formed surface of other support-attached panel for electronic device in which a color filter is formed on a second main surface of a glass substrate are stuck to each other via a sealing material or the like.

Also, the panel 40 for electronic device can be obtained from such support-attached panel 10 for electronic device. Namely, the panel 40 for electronic device having the constituent member 18 of a panel for electronic device and the flexible base material 16 can be obtained by peeling the flexible base material 16 and the resin layer 14 fixed to the supporting glass 12 from the support-attached panel 10 for electronic device.

Also, a display device can be obtained from such a panel for electronic device. Examples of the display device include LCD and OLED. Examples of a mode or a driving system of LCD include a TN type, an STN type, an FE type, a TFT type, an MIM type, an IPS type, a VA type, and so on.

### <Production Method of Support-Attached Panel for Electronic Device>

Though a production method of the foregoing support-attached panel 10 for electronic device is not particularly limited, it is preferable to produce the support-attached panel 10 for electronic device by a method in which at least a part of the constituent member of a panel for electronic device is formed on the surface of the flexible base material 16 of the foregoing glass laminate 30, and thereafter, the flexible base material 16 and a cured silicone resin layer-attached supporting glass are separated.

A method of forming at least a part of the constituent member of a panel for electronic device on the surface of the flexible base material 16 of the glass laminate 30 is not particularly limited, and a conventionally known method is carried out depending upon a kind of the constituent member of a panel for electronic device.

For example, when the case of producing OLED is taken as an example, for the purpose of forming an organic EL structure on the second main surface of the flexible base material 16 of the glass laminate 30 by adopting a production step designed for a conventional glass substrate, a variety of layer formation operations or treatments, such as formation of a transparent electrode on the second main surface of the flexible base material 16, further, vapor deposition of a hole injection layer, a hole transporting layer, a light emitting layer, an electron transporting layer, and the like on the surface having a transparent electrode formed thereon, sealing using a sealing plate, and the like, are carried out.

Specifically, examples of such layer formation operations or treatments include a film formation treatment, a vapor deposition treatment, an adhesion treatment of a sealing plate, and so on. Such a formation operation of a constituent member may be a part of formation operations of all constituent members necessary for a panel for electronic device. In that case, the panel for electronic device is produced by peeling the flexible base material 16 having a part of the constituent members formed thereon from the resin layer 14 and then forming the remaining constituent members on the flexible base material 16.

### <Production Method of Flexible Panel for Electronic Device>

The panel 40 for electronic device can be obtained by after obtaining the foregoing support-attached panel 10 for electronic device, peeling the first main surface of the flexible base material 16 in the support-attached panel 10 for electronic device and the peelable surface of the resin layer 14 from each other. As described above, in the case where the constituent member on the flexible base material 16 is a part of all constituent members necessary for a panel for electronic device at the time of peeling, thereafter, the remaining constituent members are formed on the flexible base material 16 to produce a panel for electronic device. A method of peeling the first main surface of the flexible base material 16 and the peelable surface of the resin layer 14 from each other is not particularly limited.

Specifically, for example, a sharp blade-shaped material is inserted into an interface between the flexible base material 16 and the resin layer 14 to give a trigger of peeling, and then, peeling can be carried out by blowing a mixed fluid of water and compressed air. The both can be peeled away by applying a mechanical force by suction pads 70A and 70B while incurvating the supporting substrate and the flexible substrate, respectively (see FIG. 2F). Preferably, the support-attached panel 10 for electronic device is installed on a surface plate 90 so as to not cause damage to a formed electronic device as far as possible in such a manner that the supporting glass 12 faces upward, whereas the side of the panel 40 faces downward. Then, the substrate on the panel side is sucked onto the surface plate under vacuum (in the case where the supporting glass is laminated on the both surfaces, the operation is carried out in succession), and a blade 60 is first inserted into an interface between the flexible base material 16 and the resin layer 14 (see FIG. 2F and FIG. 3) in this state.

Thereafter, the side of the supporting glass 12 is then sucked by a plurality of vacuum suction pads, and the vacuum suction pads are allowed to rise from around the position of insertion of the blade in order. Then, an air layer is formed in an interface between the resin layer 14 and the glass substrate on the panel side, and the air layer spreads into the whole of the interface, whereby the supporting glass 12 can be easily peeled therefrom (in the case where the supporting glass 12 is laminated on the both surfaces of the support-attached panel for electronic device, the foregoing peeling step is repeated for every surface). Incidentally, the present applicant disclosed in Japanese Patent Application No. 2009-026196a method or a composite structure of devices in which a laminate provided with a structure of three or more layers including a glass substrate and an easily peelable resin layer is once formed, and after a prescribed device process, a supporting substrate can be peeled away. Needless to say, specific methods and materials of the foregoing patent application are also applicable in the present application.

Also, after obtaining the foregoing panel for electronic device, further, a display device can be produced using the resulting panel for electronic device. Here, operations for obtaining a display device are not particularly limited, and for example, a display device can be produced by a conventionally known method.

For example, in the case of producing TFT-LCD as a display device, there may be included the same steps as conventionally known various steps made on the assumption of a glass substrate, such as a step of forming an array, a step of forming a color filter, a step of sticking a glass substrate having an array formed thereon and a glass substrate having a color filter formed thereon to each other via a sealing material or the like (array-filter sticking step), and the like. More specifically, examples of treatments to be carried out in these steps include washing with pure water, drying, film formation, resist liquid coating, exposure, development, etching, and resist removal. Furthermore, steps to be carried out after performing the sticking step of the TFT array substrate and the color filter substrate include a liquid crystal injection step and a step of sealing an injection port to be carried out after performing this treatment, and treatments to be carried out in these steps are exemplified.

### EXAMPLES

The present invention is hereunder specifically described with reference to the Examples and the like, but it should not be construed that the present invention is limited to these Examples.

First of all, evaluation methods of glass laminates are described.

### <Peelability Evaluation>

Ten sets of glass laminates were prepared, the second main surface of the flexible base material was sucked under vacuum onto a surface plate, and a stainless steel-made blade having a thickness of 0.1 mm was inserted into an interface between the flexible base material on one corner part of the glass laminate and the resin layer, thereby giving a trigger of peeling between the first main surface of the foregoing flexible base material and the peelable surface of the foregoing resin layer.

Then, the second main surface of the supporting glass of the glass laminate was sucked by a plurality of vacuum suction pads disposed at a pitch of 90 mm, and then, the suction pads were allowed to rise from the suction pad near the foregoing corner part, thereby peeling the first main surface of the flexible base material and the peelable surface of the resin layer from each other. This treatment was continuously repeated 10 times for each of the previously prepared ten sets of glass laminates, thereby evaluating a number of sets of laminates in which peeling could be succeeded without causing cracking of the supporting glass or breakage of the suction layer.

### <Heat Resistance Evaluation 1 (Heat Resistance Evaluation of Support)>

A sample of 50 mm square was cut out from the support having the resin layer formed on the supporting glass, and a glass substrate having the same size (thickness: 0.7 mm) was laminated on this resin surface to form an evaluation sample. This sample was placed on a hot plate heated at 300° C., heated at a temperature rising speed of 10° C. per minute, and a temperature at which foaming and expansion within the sample and a peeling phenomenon of the flexible base material were recognized was defined as a heat decomposition initiation temperature and evaluated.

### <Heat Resistance Evaluation 2 (Heat Resistance Evaluation of Glass Laminate)>

A sample of 50 mm square was cut out from each of the glass laminates to form an evaluation sample. This sample was held in a nitrogen atmosphere burning furnace of a temperature level under each of the following conditions A, B and C for 10 minutes.

Condition A: 150° C. (temperature on the assumption of a forming step of organic semiconductor)

Condition B: 220° C. (temperature on the assumption of a forming step of oxide semiconductor)

Condition C: 350° C. (temperature on the assumption of a forming step of a-Si semiconductor)

Thereafter, the presence or absence of damage of the flexible base material per se, and the presence or absence of foaming and expansion within the sample, peeling of the flexible base material, and the like were confirmed.

### Glass/Resin Laminated Film

### Production Example 1

First of all, a glass film (AN100, manufactured by Asahi Glass Co., Ltd.) having a length of 350 mm, a width of 300 mm, a plate thickness of 0.08 mm, and a linear expansion coefficient of 38×10⁻⁷/° C. was washed with an alkaline detergent by using a washing apparatus exclusive for thin sheet glass to clean its surface, thereby preparing a glass film for lamination. On the other hand, a material obtained by subjecting a surface of a transparent fluorine based film (F-CLEAN, manufactured by Asahi Glass Co., Ltd.) having a length of 350 mm, a width of 300 mm, and a plate thickness of 0.10 mm to a plasma treatment was prepared. Then, this was superimposed on the preceding glass film, and the both were laminated using a press apparatus heated at 280° C. to form a glass/resin laminated film A.

### Glass/Resin Laminated Film

### Production Example 2

First of all, a material obtained by washing a glass film (AN100, manufactured by Asahi Glass Co., Ltd.) having a length of 350 mm, a width of 300 mm, a plate thickness of 0.08 mm, and a linear expansion coefficient of 38×10⁻⁷/° C. with an alkaline detergent by using a washing apparatus exclusive for thin sheet glass to clean its surface, further spraying a 0.1% methanol solution of γ-mercaptopropylmethoxysilane onto the surface, and subsequently drying at 80° C. for 3 minutes was prepared as a glass film for lamination. On the other hand, a material obtained by subjecting a surface of a polyimide film (KAPTON 200HV, manufactured by Du Pont-Toray Co., Ltd.) having a length of 350 mm, a width of 300 mm, and a plate thickness of 0.05 mm to a plasma treatment was prepared. Then, this was superimposed on the preceding glass film, and the both were laminated using a press apparatus heated at 320° C. to form a glass/resin laminated film B.

### Constitution Example 1

First of all, a supporting glass (AN100, manufactured by Asahi Glass Co., Ltd.) having a length of 350 mm, a width of 300 mm, a plate thickness of 0.6 mm, and a linear expansion coefficient of 38×10⁻⁷/° C. was washed with pure water and subjected to UV washing to clean its surface, thereby preparing a supporting substrate.

Subsequently, a linear polyorganosiloxane having a vinyl group in both ends thereof and an organohydrogen polysiloxane having a hydrosilyl group in a molecule thereof were used as resins for forming an easily peelable resin layer. Then, these were mixed with a platinum based catalyst to prepare a mixture, which was then coated in a size of 349 mm in length and 299 mm in width on the first main surface of the foregoing supporting lass by a die coating apparatus (coating amount: 20 g/m²) and cured by heating at 210° C. for 30 minutes in the atmosphere, thereby forming a silicone resin layer having a thickness of 20 μm.

Here, a mixing ratio of the linear polyorganosiloxane and the organohydrogen polysiloxane was adjusted such that a molar ratio of the hydrosilyl group and the vinyl group (hydrosilyl group/vinyl group) was 0.9/1. The platinum based catalyst was added in an amount of 2 parts by mass relative to 100 parts by mass of a total amount of the linear polyorganosiloxane and the organohydrogen polysiloxane.

With respect to the thus obtained support, its heat resistance evaluation was carried out on the basis of the heat resistance evaluation 1. As a result, the heat resistance was found to be 460° C.

Next, each of a variety of flexible base materials, a list of which is shown in Table 1, was cut into a size of 350 mm in length and 300 mm in width and laminated on the foregoing supporting glass having a silicone resin formed thereon at ordinary temperature by using a vacuum press apparatus, thereby obtaining a glass laminate.

TABLE 1

| | Example 1 | Example 2 | Example 3 | Example 4 | Example 5 | Example 6 | Example 7 |
|---|---|---|---|---|---|---|---|
| Material of | Polyether | Polyethylene | Silicone based | Polyimide | Stainless steel | Glass/resin | Glass/resin |
| flexible base | sulfone (PES) | naphthalate | hybrid resin | | | laminated film A | laminated film B |
| material | | (PEN) | | | | | |
| Manufacturer, | Sumitomo | Teijin DuPont, | Nippon Steel | Mitsubishi | SUS304 | Manufactured | Manufactured |
| product No., | Bakelite, | Teonex Q65 | Chemical, | Gas Chemical, | | by Asahi | by Asahi |
| etc. | Sumilite ® FS- | | Silplus J-100 | Neopulim L- | | Glass | Glass |
| | 1300 | | | 3430 | | | |
| Thickness | 100 | 100 | 100 | 100 | 200 | 180 | 130 |
| (μm) | | | | | | | |
| Transparency | Transparent | Transparent | Transparent | Transparent | Non- | Transparent | Non- |
| | | | | | transparent | | transparent |
| Heat | A = ◯ | A = ◯ | A = ◯ | A = ◯ | A = ◯ | A = ◯ | A = ◯ |
| resistance | B = ◯ | B = ◯ | B = ◯ | B = ◯ | B = ◯ | B = ◯ | B = ◯ |
| evaluation 2 | C = X | C = X | C = ◯ | C = ◯ | C = ◯ | C = X | C = ◯ |
| Peelability | 10/10 | 10/10 | 10/10 | 10/10 | 10/10 | 10/10 | 10/10 |
| evaluation | OK | OK | OK | OK | OK | OK | OK |

### Examples 1 to 7

In each of the Examples, the flexible base material and the supporting glass were adhered closely to the silicone resin layer without generation of an air bubble, and no convex defect was observed, and its smoothness was satisfactory.

Also, the evaluation of peelability and the heat resistance evaluation 2 were carried out.

### Constitution Example 2

In this Example, LCD is produced using the glass laminates obtained in Constitution Example 1 (Example 1 and Example 3).

The glass laminate (D1) of Example 3 is subjected to a usual array formation step for glass substrate to form an array on the second main surface of the glass substrate. The glass laminate (D2) of Example 1 is subjected to a usual color filter formation step for glass substrate to form a color filter on the second main surface of the glass substrate.

The laminate D1 having an array formed thereon (support-attached panel for electronic device of the present invention) and the laminate D2 having a color filter formed thereon (support-attached panel for electronic device of the present invention) are stuck to each other via a sealing material in such a manner that the respective supporting glasses are positioned outward, thereby obtaining an empty cell of LCD having the laminates attached onto the both sides thereof.

Subsequently, the second main surface of the supporting glass of the laminate D1 of the foregoing empty cell is sucked under vacuum onto a surface plate, and a stainless steel-made blade having a thickness of 0.1 mm is inserted into an interface between the flexible base material and the resin layer of Example 1 on a corner part of the laminate D2, thereby giving a trigger of peeling between the first main surface of the flexible base material and the peelable surface of the resin layer of Example 1. Then, the second main surface of the supporting glass of the laminate D2 is sucked by 12 vacuum suction pads, and thereafter, the suction pads are allowed to rise sequentially from the suction pad near the corner part of the laminate D2. As a result, the supporting glass to which the resin layer derived from the laminate D2 is fixed can be peeled while leaving an empty cell of LCD having the supporting glass of the laminate D1 attached thereonto, on the surface plate.

Next, the first main surface of the flexible base material having a color filter formed on the second main surface thereof is sucked under vacuum on a surface plate, and a stainless steel-made blade having a thickness of 0.1 mm is inserted into an interface between the flexible base material and the resin layer of Example 3 on a corner part of the laminate D1, thereby giving a trigger of peeling between the first main surface of the flexible base material and the peelable surface of the resin layer of Example 3. Then, the second main surface of the supporting glass of the laminate D1 is sucked by 12 vacuum suction pads, and thereafter, the suction pads are allowed to rise sequentially from the suction pad near the corner part of the laminate D1. As a result, the supporting glass to which the resin layer is fixed can be peeled while leaving an LCD cell on the surface plate. There is thus obtained an empty cell of LCD constituted of a film substrate having a thickness of 0.1 mm on one side.

Subsequently, a liquid crystal injection step and a step of sealing an injection port are carried out to complete an LCD cell. A step of sticking the completed LCD cell to a polarizing plate is carried out, and subsequently, a module formation step is carried out to obtain LCD. The thus obtained LCD does not cause a problem in view of characteristics.

### Constitution Example 3

In this Example, OLED is produced using the glass laminates obtained in Constitution Example 1 (Example 6 and Example 7). The glass substrate D3 of Example 7 is subjected to a usual step for OLED back plate for glass substrate, and a step of forming an electrode, a step of vapor depositing a hole injection layer, a hole transporting layer, a light emitting layer, an electron transporting layer, and the like, a step of coating a barrier layer, and the like are carried out. Then, the glass substrate D4 of Example 6 is subjected to a usual step for OLED front plate for glass substrate.

The laminate D3 having a back plate array for OLED formed thereon (support-attached panel for electronic device of the present invention) and the laminate D4 having a front plate for OLED formed thereon (support-attached panel for electronic device of the present invention) are stuck to each other via a sealing material in such a manner that the respective supporting glasses are positioned outward, thereby obtaining an OLED panel of top emission type having the laminates attached onto the both sides thereof.

Subsequently, the side of the laminate D4 is sucked under vacuum onto a surface plate, and thereafter, a stainless steel-made blade having a thickness of 0.1 mm is inserted into an interface between the flexible base material and the resin layer on a corner part of the laminate D3, thereby giving a trigger of peeling between the first main surface of the flexible base material and the peelable surface of the resin layer. Then, the second main surface of the supporting glass of the laminate D3 is sucked by 9 vacuum suction pads, and thereafter, the suction pads are allowed to rise sequentially from the suction pad near the corner part of the laminate D3. As a result, the supporting glass to which the resin layer derived from D3 is fixed can be peeled while leaving only an organic EL panel substrate constituted of the flexible base material of the glass laminate D4 and the flexible base material of Example 7 on a surface plate.

Next, the first main surface of the flexible base material having a back plate of organic EL formed on the second main surface thereof is sucked under vacuum on a surface plate, and a stainless steel-made blade having a thickness of 0.1 mm is inserted into an interface between the glass substrate and the resin layer on a corner part of the laminate D4, thereby giving a trigger of peeling between the first main surface of the flexible base material and the peelable surface of the resin layer of Example 6. Then, the second main surface of the supporting glass of the laminate D4 is sucked by 12 vacuum suction pads, and thereafter, the suction pads are allowed to rise sequentially from the suction pad near the corner part of the laminate D4. As a result, the supporting glass to which the resin layer derived from D4 is fixed can be peeled while leaving only an organic EL cell on the surface plate. There is thus obtained a film-shaped organic EL cell having a panel thickness of 0.31 mm. Thereafter, a module formation step is carried out to fabricate OLED. The thus obtained OLED does not cause a problem in view of characteristics.

### Constitution Example 4

First of all, a supporting glass (AN100, manufactured by Asahi Glass Co., Ltd.) having a length of 350 mm, a width of 300 mm, a plate thickness of 0.6 mm, and a linear expansion coefficient of 38×10⁻⁷/° C. was washed with pure water and subjected to UV washing to clean its surface, thereby preparing a supporting substrate.

Subsequently, a linear polyorganosiloxane having a vinyl group in both ends thereof, a branched polyorganosiloxane having a vinyl group, and an organohydrogen polysiloxane having a hydrosilyl group in a molecule thereof were used as resins for forming an easily peelable resin layer. The branched polyorganosiloxane is corresponding to the foregoing polyorganosiloxane (B).

A mixed weight ratio of the linear polyorganosiloxane (A) and the branched polyorganosiloxane (B) (A/B) was set to 40/60. Also, a mixing ratio of the linear polyorganosiloxane, the branched polyorganosiloxane, and the organohydrogen polysiloxane was adjusted such that a molar ratio of the hydrosilyl group and the vinyl group (hydrosilyl group/vinyl group) was 0.9/1.

Subsequently, this resin was mixed with a platinum based catalyst to prepare a mixture, which was then coated in a size of 349 mm in length and 299 mm in width on the first main surface of the foregoing supporting lass by a die coating apparatus (coating amount: 20 g/m²) and cured by heating at 210° C. for 30 minutes in the atmosphere, thereby forming a silicone resin layer having a thickness of 20 μm.

Here, the platinum based catalyst was added in an amount of 2 parts by mass relative to 100 parts by mass of a total amount of the linear polyorganosiloxane, the branched polyorganosiloxane, and the organohydrogen polysiloxane.

An evaluation sample having a length of 25 mm and a width of 75 mm was cut out from the thus obtained support. The evaluation sample is composed of a supporting glass and a silicone resin layer fixed onto an entire surface of the supporting glass. On this evaluation sample, a flexible base material having a length of 25 mm and a width of 50 mm was laminated at ordinary temperature by using a vacuum press apparatus, thereby obtaining a glass laminate. A polyimide film (Neopulim L-3430, manufactured by Mitsubishi Gas Chemical Company, Inc.) was used as the flexible base material.

A peeling strength between the resin layer surface and the polyimide film surface in this glass laminate was measured by the foregoing measurement method and found to be 0.2 N/25 mm. Incidentally, in a glass laminate obtained by similarly cutting out an evaluation sample from the support of Constitution Example 1 and laminating a polyimide film thereon, a peeling strength between the resin layer surface and the polyimide film surface was found to be 0.05 N/25 mm.

### Constitution Example 5

In Constitution Example 5, a support was obtained in the same manner as that in Constitution Example 4, except that after cleaning the support glass surface and before installing the resin layer on the supporting glass surface, the supporting glass surface was subjected to a surface treatment with a silane coupling agent. The surface treatment was carried out by coating a solution obtained by diluting vinyl trimethoxysilane (KBM1003, manufactured by Shin-Etsu Chemical Co., Ltd.) to 0.25% by mass with isopropyl alcohol on the supporting glass surface, followed by heat treatment at 100° C. for one minute.

Subsequently, an evaluation sample was cut out from the resulting support in the same manner as that in Constitution Example 4, and the resin layer surface of the evaluation sample was subjected to a UV ozone treatment using a surface treatment apparatus (PL21-200, manufactured by Sen Lights Corporation) under the following condition.

Dominant wavelength of UV light: 185 nm, 254 nm

Illuminance of UV light: 7 mW/cm² (measuring wavelength: 254 nm)

Irradiation dose of UV light: 400 mJ/cm² (measuring wavelength: 254 nm)

Ozone concentration: 20 ppm (volume ratio)

Thereafter, a polyimide film (Neopulim L-3430, manufactured by Mitsubishi

Gas Chemical Company, Inc.) was laminated on the evaluation sample in the same manner as that in Constitution Example 4, thereby obtaining a glass laminate.

A peeling strength between the resin layer surface and the polyimide film surface in this glass laminate was measured by the foregoing measurement method and found to be 1.0 N/25 mm. Also, peeling at an interface between the supporting glass and the resin layer was not observed.

Incidentally, in a glass laminate obtained by similarly cutting out an evaluation sample from the support of Constitution Example 1, subjecting the resin layer surface of the evaluation sample to the foregoing ozone treatment, and then laminating a polyimide film thereon, a peeling strength between the resin layer surface and the polyimide film surface was found to be 0.06 N/25 mm.

### Constitution Example 6

In Constitution Example 6, a support was obtained in the same manner as that in Constitution Example 4, except that a silane coupling agent was added to the resins for forming an easily peelable resin layer. The addition treatment was carried out by adding 3 parts by mass of vinyl trimethoxysilane (KBM1003, manufactured by Shin-Etsu Chemical Co., Ltd.) to 100 parts by mass of a total sum of the linear polyorganosiloxane, the branched polyorganosiloxane, and the organohydrogen polysiloxane.

Subsequently, an evaluation sample was cut out from the resulting support in the same manner as that in Constitution Example 4, and the resin layer surface of the evaluation sample was subjected to a UV ozone treatment using a surface treatment apparatus (PL21-200, manufactured by Sen Lights Corporation) under the following condition.

Dominant wavelength of UV light: 185 nm, 254 nm

Illuminance of UV light: 7 mW/cm² (measuring wavelength: 254 nm)

Irradiation dose of UV light: 400 mJ/cm² (measuring wavelength: 254 nm)

Ozone concentration: 20 ppm (volume ratio)

Thereafter, a polyimide film (Neopulim L-3430, manufactured by Mitsubishi Gas Chemical Company, Inc.) was laminated on the evaluation sample in the same manner as that in Constitution Example 4, thereby obtaining a glass laminate.

A peeling strength between the resin layer surface and the polyimide film surface in this glass laminate was measured by the foregoing measurement method and found to be 1.0 N/25 mm. Also, peeling at an interface between the supporting glass and the resin layer was not observed.

### Constitution Example 7

A glass laminate was obtained in the same manner as that in Constitution Example 4, except that the mixing weight ratio of the linear polyorganosiloxane (A) and the branched polyorganosiloxane (B) (A/B) was set to 60/40.

A peeling strength between the resin layer surface and the polyimide film surface in this glass laminate was measured by the foregoing measurement method and found to be 0.1N/25 mm.

### Constitution Example 8

In Constitution Example 8, a support was obtained in the same manner as that in Constitution Example 7, except that after cleaning the support glass surface and before installing the resin layer on the supporting glass surface, the supporting glass surface was subjected to a surface treatment with a silane coupling agent. The surface treatment was carried out by coating a solution obtained by diluting vinyl trimethoxysilane (KBM1003, manufactured by Shin-Etsu Chemical Co., Ltd.) to 0.25% by mass with isopropyl alcohol on the supporting glass surface, followed by heat treatment at 100° C. for one minute.

Subsequently, an evaluation sample was cut out from the resulting support in the same manner as that in Constitution Example 4, and the resin layer surface of the evaluation sample was subjected to a UV ozone treatment using a surface treatment apparatus (PL21-200, manufactured by Sen Lights Corporation) under the following condition.

Dominant wavelength of UV light: 185 nm, 254 nm

Illuminance of UV light: 7 mW/cm² (measuring wavelength: 254 nm)

Irradiation dose of UV light: 400 mJ/cm² (measuring wavelength: 254 nm)

Ozone concentration: 20 ppm (volume ratio)

Thereafter, a polyimide film (Neopulim L-3430, manufactured by Mitsubishi Gas Chemical Company, Inc.) was laminated on the evaluation sample in the same manner as that in Constitution Example 4, thereby obtaining a glass laminate.

A peeling strength between the resin layer surface and the polyimide film surface in this glass laminate was measured by the foregoing measurement method and found to be 0.4 N/25 mm. Also, peeling at an interface between the supporting glass and the resin layer was not observed.

### Constitution Example 9

A glass laminate was obtained in the same manner as that in Constitution Example 4, except that the mixing weight ratio of the linear polyorganosiloxane (A) and the branched polyorganosiloxane (B) (A/B) was set to 10/90.

A peeling strength between the resin layer surface and the polyimide film surface in this glass laminate was measured by the foregoing measurement method and found to be 0.3 N/25 mm.

Also, this glass laminate was subjected to the heat resistance evaluation 2. As a result, a result of A=◯, B=x, and C=x was obtained.

### Comparative Example

A support was fabricated in the same manner in Constitution Example 1, except that the used silicone resin was changed to a pressure-sensitive adhesive (acrylic curable pressure-sensitive adhesive, manufactured by Nitto Denko Corporation) capable of lowering a pressure-sensitive adhesive force upon irradiation with light). This support was subjected to the heat resistance evaluation 1. However, white smoke was rapidly generated on a hot plate at 300° C., and conspicuous deterioration of the resin layer was recognized.

On this support, the PES film described in Example 1 was laminated in the same manner as that in Constitution Example 1. As a result, the flexible base material and the supporting glass were adhered closely to the pressure-sensitive adhesive layer without generation of an air bubble, and no convex defect was observed, and its smoothness was satisfactory. This laminate was irradiated with ultraviolet rays to lower the pressure-sensitive adhesive force, and thereafter, the preceding peelability evaluation was carried out. As a result, the peeling strength was too strong in the peeling process, so that all of the supporting glasses were broken. Subsequently, this laminate was subjected to the heat resistance evaluation 2. As a result, a result of A=◯, B=x, and C=x was obtained.

While the present invention has been described in detail and with reference to specific embodiments thereof, it will be apparent to one skilled in the art that various changes and modifications can be made therein without departing from the spirit and scope of the present invention.

This application is based on Japanese Patent Application No. 2009-197201 filed on Aug. 27, 2009, the contents of which are incorporated herein by way of reference.

### INDUSTRIAL APPLICABILITY

According to the present invention, a laminated structure which is excellent in heat resistance and in which a flexible base material and its support adhered closely to each other can be easily separated from each other can be provided. Also, a support-attached panel for electronic device which is obtained by using this laminated structure can be provided. Furthermore, a method for producing a panel for electronic device using the foregoing laminated structure can be provided.

### DESCRIPTION OF REFERENCE NUMERALS AND SIGNS

10: Support-attached panel for electronic device
12: Supporting glass
14: Resin layer
16: Flexible base material
18: Constituent member of panel for electronic device
20: Support
30: Glass laminate (glass laminated structure)
40: Panel for electronic device
60: Blade
70A, 70B: Suction pad
80: Die (slot orifice)
90: Surface plate

1. A laminated structure comprising:
a flexible base material having a first main surface and a second main surface and having a thickness of 0.3 mm or less;
a supporting substrate; and
a cured silicone resin layer provided between the flexible base material and the supporting substrate and having a peelable surface,
wherein the cured silicone resin layer is fixed onto a first main surface of the supporting substrate, has easy peelability against the first main surface of the flexible base material, and is adhered closely to the first main surface of the flexible base material.

2. The laminated structure according to claim 1, wherein the cured silicone resin layer having the peelable surface is a crosslinking reaction product of a curable silicone resin composition containing a linear polyorganosiloxane having a vinyl group in both ends and/or side chain thereof and an organohydrogen polysiloxane having a hydrosilyl group in a molecule thereof.

3. The laminated structure according to claim 2, wherein a mixing ratio of the linear polyorganosiloxane and the organohydrogen polysiloxane is from 1.3/1 to 0.7/1 in terms of a molar ratio of a hydrosilyl group and a vinyl group (hydrosilyl group/vinyl group).

4. The laminated structure according to claim 1, wherein the flexible base material comprises a resin film having a 5% heat weight reduction temperature of 150° C. or higher.

5. The laminated structure according to claim 1, wherein the flexible base material comprises a metal film.

6. The laminated structure according to claim 1, wherein the flexible base material comprises a laminate of a glass film having a thickness of 0.1 mm or less and a resin film having a thickness of 0.2 mm or less and having a 5% heat weight reduction temperature of 150° C. or higher, and the second main surface of the flexible base material is a surface of the glass film.

7. The laminated structure according to claim 1, wherein the cured silicone resin layer having the peelable surface is formed by curing the curable silicone resin composition in such a state that it comes into contact with the surface of the supporting substrate and does not come into contact with the flexible base material to form the cured silicone resin layer, and then bringing it into contact with the surface of the flexible base material.

8. The laminated structure according to claim 1, wherein the supporting substrate is a glass substrate.

9. The laminated structure according to claim 2, wherein the curable silicone resin composition further contains a polyorganosiloxane containing an R¹₃SiO_{0.5} unit (R¹ is an aliphatic unsaturated bond-free monovalent hydrocarbon group having 1 to 10 carbon atoms) and an SiO₂ unit and having a molar ratio of the R¹₃SiO_{0.5} unit to the SiO₂ unit of from 0.5 to 1.7.

10. The laminated structure according to claim 9, wherein the curable silicone resin composition has a mixing weight ratio (A/B) of the linear polyorganosiloxane (A) having a vinyl group in both ends and/or side chain thereof and the polyorganosiloxane (B) containing an R¹₃SiO_{0.5} unit and an SiO₂ unit and having a molar ratio of the R¹₃SiO_{0.5} unit to the SiO₂ unit of from 0.5 to 1.7, of from 20/80 to 80/20.

11. The laminated structure according to claim 1, wherein a surface of the cured silicone resin layer on the side of the flexible base material is a surface having been subjected to a UV ozone treatment before installation of the flexible base material.

12. The laminated structure according to claim 1,
wherein the surface of the supporting substrate on the side of the cured silicone resin layer is a surface having been subjected to a surface treatment with a silane coupling agent before installation of the cured silicone resin layer or the curable silicone resin composition to be the cured silicone resin layer, or
the cured silicone resin layer is obtained by curing the curable silicone resin composition containing a silane coupling agent.

13. A support-attached panel for display device, for producing a panel for display device, wherein at least a part of a constituent member of the panel for display device is formed on a surface of the flexible base material of the laminated structure according to claim 1.

14. A method for producing a panel for display device, the method comprising:
forming at least a part of a constituent member of the panel for display device on a surface of the flexible base material of the laminated structure according to claim 1; and
thereafter, separating the flexible base material and the cured silicone resin layer-attached supporting substrate from each other.

15. A support-attached panel for light generating device, for producing a panel for light generating device, wherein at least a part of a constituent member of the panel for light generating device is formed on a surface of the flexible base material of the laminated structure according to claim 1.

16. A method for producing a panel for light generating device, the method comprising:
forming at least a part of a constituent member of the panel for light generating device on a surface of the flexible base material of the laminated structure according to claim 1; and
thereafter, separating the flexible base material and the cured silicone resin layer-attached supporting substrate from each other.
